(19) United States
(12) Patent Application Publication
(10) Pub. No.: US 2005/0210152 A1
(43) Pub. Date: Sep. 22, 2005

(54) Providing availability information using a distributed cache arrangement and updating the caches using peer-to-peer synchronization strategies

(75) Inventor: Richard M. Hawes, Mountain View, CA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/803,230

(22) Filed: Mar. 17, 2004

(51) Int. Cl. G06F 15/16

(52) U.S. Cl. 709/248; 709/227

(57) ABSTRACT

A system includes multiple server modules forming a server farm. Each server module includes one or more application caches which store availability information that indicates whether a corresponding application is available or unavailable. When a user makes a request for an application, the appropriate server module accesses its application cache to determine whether the application is available; if not, the server farm quickly notifies the user of the unavailability of the application. Further, synchronization strategies are described for distributing availability information among the server modules in the system, and for updating a server module that has recently become active with current availability information stored by other reference server modules.

### TECHNICAL FIELD

This invention relates to notifying a user of the unavailability of an application provided by a data processing system. This invention also relates to a strategy for updating information in a data processing system, and, in a more particular implementation, to a strategy for updating availability information in a data processing system that includes multiple server modules.

### BACKGROUND

Companies and other organizations commonly provide resources over the Internet using a cluster of servers, referred to as a server farm. A server farm may allocate different servers to handle respective processing tasks or services. In this case, the server farm can route a user's request to an appropriate server that performs the service referenced by the user's request. Alternatively, or in addition, the server farm may allocate a group of redundant servers for handling the same task. In this case, load balancing functionality provided by the server farm can dynamically determine which server in the group of redundant servers is best able to handle the user's request at a particular point in time. In general, different processing environments can rely on different resource and processing allocation schemes to best service the requests of its users, depending on the unique characteristics of these different processing environments.

FIG. 1 shows a high-level architecture associated with an exemplary server farm 102. The server farm 102 includes an exemplary collection of servers (104, 106, 108, . . . 110). Each of these servers (104, 106, 108, . . . 110) has access to a collection of resources (112, 114, 116, . . . 118). The resources (112, 114, 116, . . . 118) loosely represent any processing functionality and/or information used to respond to users' requests. To facilitate illustration, the resources (112, 114, 116, . . . 118) are shown as distinct entities that are coupled to respective servers (104, 106, 108, . . . 110). However, more broadly, the resources (112, 114, 116, . . . 118) can represent any functionality and/or information provided at any location. For instance, the resources A 112 accessible to server A can refer to processing functionality and/or information actually implemented on server A 104 itself. In one implementation, the functionality and/or information in resources A 112 can be entirely unique and non-overlapping with respect to the functionality and/or information in resources B 114. In another implementation, certain functionality and/or information in resources A 112 can be common to that of resources B 114; this commonality can be achieved by either the storage of redundant copies of the same resources, or by access to a single copy of shared common resources.

In any case, users (120, 122, . . . 124) can access the resources (112, 114, 116, . . . 118) via a wide area network (WAN) packet network (126) (such as the Internet) via respective client modules (128, 130, . . . 132) (such as respective personal computers or application-specific processing devices). For instance, FIG. 1 shows an exemplary user 122 accessing the resources (112, 114, 116, . . . 118) of the server farm 102 using client module B 130. This request is denoted by arrow 134. The server farm 102 can route the request 134 to an appropriate server (or servers) and associated resources depending on the nature of the request 134 and/or based on load-balancing considerations. In the illustrative and exemplary case of FIG. 1, the server farm 102 determines that server C 108 and associated resources C 116 should handle the request 134. A response will be formulated using resources C 116 and sent back to the user 122 over the WAN 126.

However, server farms sometimes fail to provide the services requested by their users. There are many causes of this failure. In one case, there may be an equipment malfunction associated with the servers (104, 106, 108, . . . 110) and/or associated resources (112, 114, 116, . . . 118). In another case, parts of (or the entirety of) the server farm 102 can be brought offline to perform maintenance or service upgrades, etc. Whatever the case, the users (120, 122, . . . 124) cannot interact with the server farm 102 in the normal manner during these down times. In a common scenario, the users (120, 122, . . . 124) will receive various errors messages (such as error message 136) when they submit requests to the server farm 102. The server farm 102 itself can generate these error messages by detecting the inability to access the needed resources. Alternatively, some other entity (such as an Internet Service Provider) can provide these messages on behalf of the server farm 102. For instance, this other entity can generate a failure message if the server farm 102 fails to respond within a predetermined period of time (such as 30 seconds).

The above solutions to error conditions are not fully satisfactory. For instance, the user 122's request may have required the user 122 to perform various time-consuming actions, such as typing in various data. If the request cannot be processed by the server farm 102 then this effort is wasted and must be repeated when the server farm 102 becomes operational. For instance, consider the exemplary case in which the user 122 is relying on the server farm 102 to transmit the user 122's email message. This message may take an appreciable amount of time to type in. If the server farm 102 cannot process this email because of equipment failure (or because of any other reason), the email may be “lost,” thus requiring the user 122 to retype this message at a later time when the server farm 102 is operational again. Needless to say, such a failure in the server farm 102 can frustrate the user 122.

Accordingly, there is an exemplary need for a more effective strategy for alerting users to the unavailability of system resources in a server farm including multiple servers. There is another need for maintaining the integrity (e.g., currency) of information in any system which implements such a strategy. However, the above-described needs are merely representative of many kinds of deficiencies in existing systems that rely on multiple processing modules to provide services; accordingly, more broadly stated, there is an exemplary need for more effective strategies for providing services using a system including multiple processing modules.

### SUMMARY

According to one exemplary implementation, a method is described for advising a user of the availability of an application in a system including plural server modules. The method includes: (a) receiving, at a server module in the system, a user's request for an application; (b) consulting an application store associated with the application to determine whether the application is unavailable, and, if so generating a response; and (c) forwarding the response to the user, wherein each of the plural server modules in the system maintains its own respective application store.

According to another exemplary implementation, a method is described for synchronizing a system including plural server modules. The method includes: (a) receiving notification information at a first server module regarding a change in the system; (b) acting on the notification information in the first server module; and (c) propagating the notification information from the first server module to at least a second server module. The notification information can pertain to an indication of whether or not at least one application used by the system is available to service user requests.

According to another exemplary implementation, another method is described for synchronizing a system including plural server modules. The method includes: (a) sending first status information reflecting a state in a first server module to a second server module; (b) merging the first status information with second status information, the second status information reflecting a state of the second server module, to produce merged information; (c) sending the merged information from the second server module to the first server module; and (d) acting on the merged information at the first server module. The status information can include notification information regarding a change in the system. More specifically, the notification information can comprise an indication of whether or not at least one application used by the system is available to service user requests.

Additional implementations and features will be described in the following.

### BRIEF DESCRIPTION OF THE DRAWINGS

FIG. 1 shows a conventional system for providing services to users using a server farm.

FIG. 2 shows a system for providing services to users using a server farm including multiple application caches and synchronization functionality.

FIG. 3 shows the use of the synchronization functionality illustrated in FIG. 2 to synchronize the system when a server module returns to service after having been inactive for any reason.

FIG. 4 shows an exemplary procedure for notifying users of the unavailability of resources using the multiple application caches shown in FIG. 2.

FIG. 5 shows an exemplary procedure for disseminating availability information throughout the system shown in FIG. 2.

FIG. 6 shows an exemplary procedure for synchronizing a starting server module with the rest of the system of FIG. 2 when the starting server module returns to service after having been inactive for any reason.

FIG. 7 complements FIG. 6 by showing how a reference server module interacts with the starting server module to assist the starting server module to synchronize itself with respect to the rest of the system.

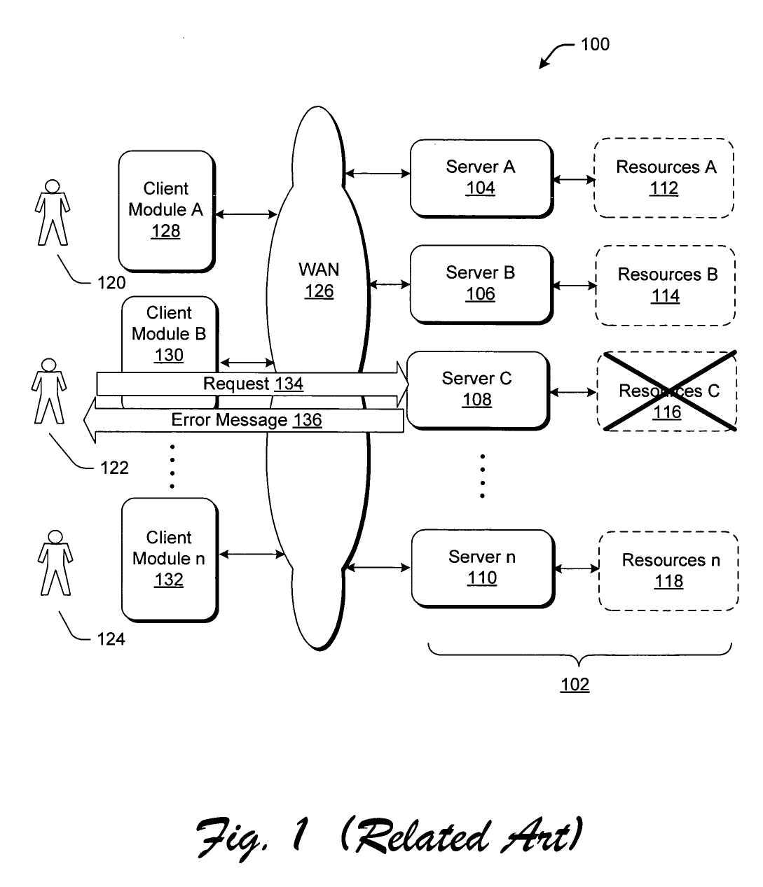

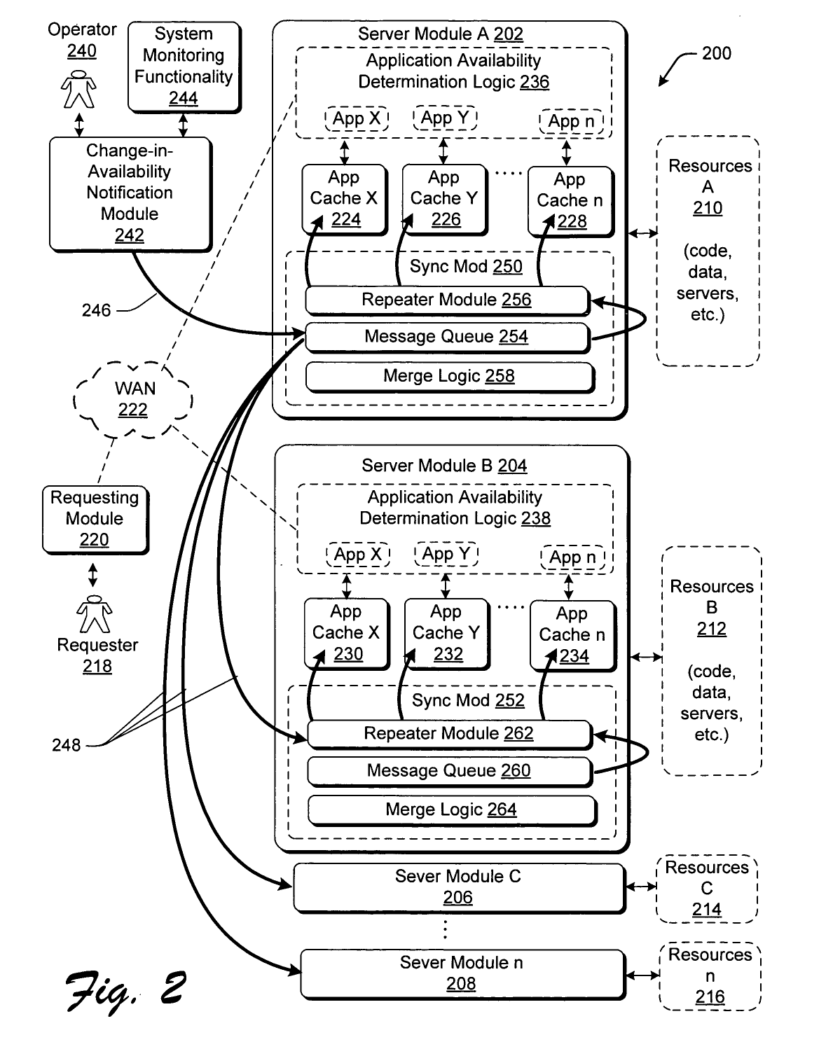

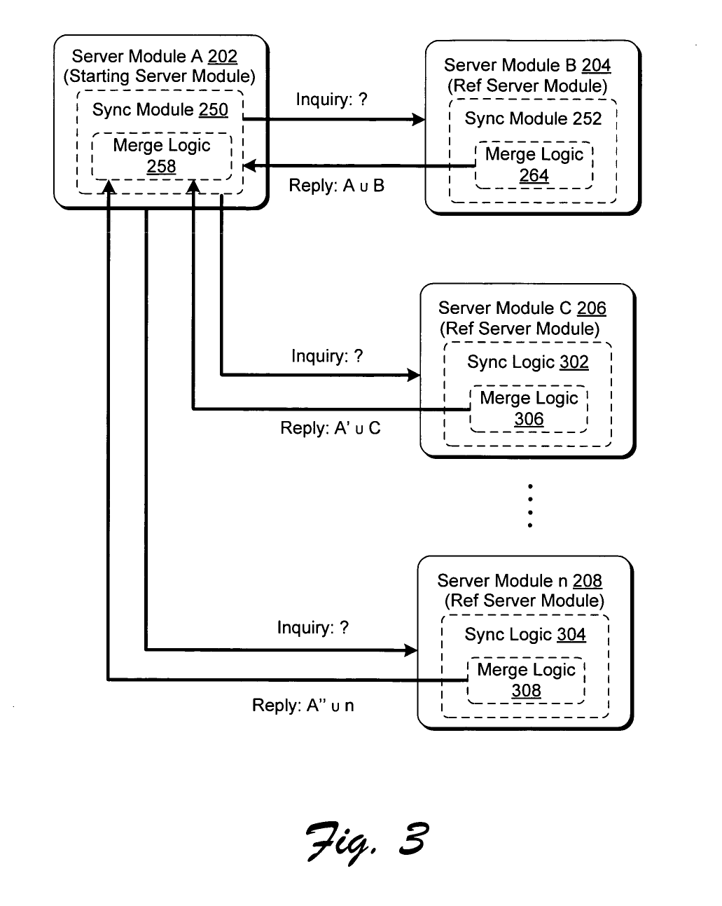

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

Any of the functions described herein can be implemented using software, firmware (e.g., fixed logic circuitry), manual processing, or a combination of these implementations. The term “logic” or “module” as used herein generally represents software, firmware, or a combination of software and firmware. For instance, in the case of a software implementation, the term “logic” or “module” represents program code that performs specified tasks when executed on a processing device or devices (e.g., CPU or CPUs). The program code can be stored in one or more computer readable memory devices. The illustrated separation of logic and modules into distinct units may reflect an actual physical grouping and allocation of such software and/or hardware, or can correspond to a conceptual allocation of different tasks performed by a single software program and/or hardware unit. The illustrated logic and modules can be located at a single site (e.g., as implemented by a single processing device), or can be distributed over plural locations.

To provide concrete examples, the synchronization strategies are described in the specific context of a system which updates availability information among multiple server modules. The availability information indicates whether applications that can be accessed by the server modules are available or unavailable. However, the synchronization strategies can be employed in other kinds of systems to update other kinds of information.

A. Exemplary Architecture

Overview of Architecture

FIG. 2 shows a system 200 including a server farm including plural server modules (202, 204, 206, . . . 208). As described above, a server farm refers to a collection or a cluster of server modules (and associated equipment). The server modules (202, 204, 206, . . . 208) can be located at a single site or distributed over plural sites.

The term “server module” itself can refer to any functionality for providing services to a user. In one exemplary case, a “server module” corresponds to a server-type programmable computer. The server-type programmable computer can include one or more processors, volatile and non-volatile memory for storing machine readable code and other information, media access functionality, interface functionality, etc. In another case, the term “server module” can refer to separate code modules implemented by a single server-type programmable computer, each for implementing server functionality. In another case, the term “server module” can pertain to, in whole or in part, fixed (e.g., non-programmable) logic circuitry for implementing server functionality. Still other implementations can be provided.

Each server module (202, 204, 206, . . . 208) has access to various resources (210, 212, 214, . . . 216) used to perform some service. Resources (210, 212, 214, . . . 216) can include processing functionality (e.g., machine readable code, processing equipment, etc.), information (e.g., database records), or other machine readable “objects.” As in the case described for the system 100 of FIG. 1, the coupling between server modules (202, 204, 206, . . . 208) and resources (210, 212, 214, . . . 216) should be construed generally to encompass multiple different interpretations and corresponding implementations. Generally, FIG. 2's labeling of separate resource blocks with separate letters (i.e., A, B, C, etc.) can denote separate and non-overlapping groups of resource items, but need not. Consider, for example, the representative case in which server module A 202 has access to resources A 210, and server module B 204 has access to resources B 212. In this case, resources A 210 can refer to a set of resource items that is unique and non-overlapping with respect to the set of resource items associated with resources B 212. Alternatively, a subset of resource items in resources A 210 can also be present in resources B 212, or indeed, all of the resource items in resources A 210 can be present in resources B 212 (that is, in this example, resources A 210 and resources B 212 describe the same set of resource items). This commonality can be achieved by providing two separate copies of the common resource items corresponding to resources A 210 and resources B 212, respectively. Alternatively, this commonality can be implemented by providing a single copy of the shared resource items that is accessible to server module A 202 and server module B 204, respectively. Finally, the resources (210, 212, 214, . . . 216) are shown as coupled to and separate from respective server modules (202, 204, 206, . . . 208); however, the resources (210, 212, 214, . . . 216) can also refer, in whole or in part, to resource items that are implemented by the server modules (202, 204, 206, . . . 208) themselves.

Further, although only one tier (level) of server modules (202, 204, 206, . . . 208) is shown in FIG. 2, the system 200 can include multiple tiers (levels) of server modules. For instance, a first company can maintain a first tier of server modules which use a second tier of server modules maintained by another company or maintained by a whole series of partner companies. This second tier of server modules can be viewed as resources of the first tier of server modules.

The types of services (and associated resources) provided by the system 200 can vary depending on the specific processing environment in which the system 200 is employed. A representative and non-limiting list of possible services include: email handling services; chat room services; information searching services; electronic commerce (e.g., online shopping) services; parental control services; web page creation services; help information services; online television user interface services; messenger-type services; information center services pertaining to various topics, etc. For example, the system 200 can implement, in whole or in part, the services provided by Microsoft Corporation's MSN network or MSN TV network (provided by Microsoft Corporation of Redmond, Wash.). Again, these implementations pertain to only a representative sampling of possible services that the system 200 can provide.

In any case, a user 218 can access the services provided by system 200 using exemplary requesting module 220 via a wide area network (WAN) 222, such as the Internet. The Transmission Control Protocol (TCP) and the Internet Protocol (IP) can be used to couple the requesting module 220 to the server modules (202, 204, 206, . . . 208) in the system 200. However, other networks can be used, such as an intranet, a local area network (LAN), and so forth. A WAN (e.g., the Internet, etc.) or some other local network (e.g., a LAN, point-to-point connectivity, etc.) can be used, in whole or in part, to implement communication between server modules (202, 204, 206, . . . 208) in the system 200. The requesting module 220 itself can be implemented by any kind of computer (e.g., a general purpose computer), any kind of application specific device (e.g., a specific kind of set-top box that couples to a user's television, etc.), and so on. The illustrated single user 218 and associated requesting module 220 are merely representative of many such users and associated requesting modules (not shown) that can interact with the system 200 via the WAN 222.

Functionality for Determining Application Availability Each of the server modules (202, 204, 206, . . . 208) can implement one or more “applications.” Applications may pertain to different functionality that, taken together, perform a service provided by the server modules (202, 204, 206, . . . 208). For instance, these different applications may represent different code modules performing different respective collections of tasks that, taken together, perform a service. Alternatively, the applications can be selectively invoked by the user 218 without necessarily performing other applications. Each of the applications may draw from all or some of the resources (210, 212, 214, 216 . . . ). For instance, an application that provides a telephone directory lookup may draw from a resource that constitutes a list of names and telephone numbers.

In any case, at any time, an application may have an available status or an unavailable status. An application is available if it can be used to provide services to the user 218 upon request. An application is unavailable if it cannot provide these services for any number of reasons. One reason that an application can be unavailable is because the equipment that implements the application and/or its associated resources are not working properly. Another reason that an application can be unavailable is that the machine readable code that implements the application is not operating properly. Another reason that an application can be unavailable is that the resources (e.g., database records or other “objects”) that are used by the application are not working properly. Another reason that an application can be unavailable is that the application and/or its associated resources have been brought “off line” for maintenance, testing or upgrading. These reasons are merely representative and exemplary; the unavailability of the applications may be attributed to other reasons.

Each server module (202, 204, 206, . . . 208) can include one or more application stores. In one implementation, these application stores can be implemented as caches, and will be referred to from this point on as caches. (A cache refers to an in-memory store that can be quickly accessed by a referencing source.) For instance, server module A 202 includes application caches 224, 226, . . . 228, while server module B 204 includes application caches 230, 232, . . . 234. Each of the application caches (224, . . . 234) is associated with a particular application (not shown) used by the server modules (202, 204, 206, . . . 208). More specifically, the application caches (224, . . . 234) can be implemented “in process” with respect to their associated applications to facilitate interaction between the applications and their respective application caches (224, . . . 234).

In one implementation, the application caches (224, . . . 234) store availability information. The availability information indicates, for each application, whether the application is available to user requests or is not available to user requests. Accordingly, in one implementation, this availability information can be conveyed, for each application cache (224, . . . 234) by a binary value, e.g., having a value of 1 (for available) and a value of 0 (for not available). In another implementation, the availability information can include additional data. For instance, if the application is not available, the availability information can convey information that specifies the reasons for this unavailability. For instance, different codes can be assigned to different reasons for unavailability, such as: “0” signifying that the cause of the unavailability is unknown; “1,” indicating that the application is unavailable because of planned maintenance (where the availability information can also convey the expected downtime duration); “2,” indicating that the application is unavailable because of an unplanned outage; “3,” indicating that the application is unavailable because testing is being performed on the application, and so on. Also, in the case of unavailability due to application failure, the availability information can provide a code that identifies the component of the server farm that is attributed to the failure (that is, assuming that the source of the failure can be determined). The above-specified categories are merely exemplary reasons that may explain the cause of a failure. The availability information can be tailored to suit the characteristics of different processing environments.

Each server module (202, 204, 206, . . . 208) includes application availability determination logic (236, 238, . . . ), referred to for brevity as AAD logic (236, 238, . . . ). The role of the AAD logic (236, 238, . . . ) is to receive the user 218's request and to determine whether that request can be satisfied by the system 200. The AAD logic (236, 238, . . . ) performs this role by accessing the appropriate application cache(s) (224, . . . 234) to read the availability information contained therein. More specifically, when the user 218 makes a request, front end processing functionality (not shown) provided by the system 200 can determine what server module (202, 204, 206, . . . 208) is allocated to servicing this request. This can be determined on the basis of addressing information in the request itself, and/or based on load-balancing considerations. When an appropriate server module (202, 204, 206, . . . 208) receives the request, its associated AAD logic (236, 238, . . . ) then determines what application (or applications) it invokes. (This can be based on an analysis of information in the request itself, and/or based on other considerations). It then accesses the appropriate application cache (224, . . . 234) to read the availability information contained therein.

Providing that the appropriate application cache (224, . . . 234) indicates that the application is available, then the AAD logic (236, . . . 238) can instruct the appropriate server module functionality and associated resources to perform that application. But in the case that the application cache (224, . . . 234) indicates that the application is not available, then the AAD logic (236, 238, . . . ) can generate an error message for transmission to the user 218. The error message can alert the user 218 to the fact that the application is unavailable. It can further convey any of the supplemental information contained in the appropriate application cache (224, . . . 234), such as an indication of why the application is unavailable, and an indication of when the application may become available.

The server modules (202, 204, 206, . . . 208) preferably invoke their respective AAD logic (236, 238, . . . ) immediately after a request from the user 218 is received. This provides the user 218 with an error message (in the event that an application is not available) soon after the user 218 makes initial contact with the system 200. This also alleviates some of the problems described in the Background section. For instance, if the user 218 is using the system 200 to send an email, then the relevant server module (202, 204, 206, . . . 208) will inform the user 218 immediately of the unavailability of the email service. This will prevent the user 218 from spending time composing the email to only later find out that the email service is unavailable, e.g., when he or she attempts to send it.

Also, the allocation of separate application caches (224, . . . 234) to separate applications yields other benefits. Namely, because the server modules (202, 204, 206, . . . 208) store the availability information locally in caches, this information can be retrieved very quickly (as opposed to storing this information at a central location in a non-volatile storage media, such as a disk storage). Further, allocating separate availability information on an application-by-application basis allows the system 200 to provide fine-grained availability information to the user 218, and also potentially allows the system 200 to continue to provide services even though some of its applications and associated resources may be unavailable; in marked contrast; some systems grant access to their services on an all-or-nothing system-wide basis.

The above-identified advantages are merely exemplary and do not represent all of the potential benefits that the distributed cache scheme may yield when applied to different technical environments.

Functionality for Disseminating Availability Information to the Distributed Application Caches

The availability of applications can change over time. Accordingly, the system 200 provides a mechanism for disseminating changes in availability information to the various application caches (224, . . . 234) used in the system 200. This functionality is described below.

To begin with, the system 200 can learn of changes in the availability of its applications (224, . . . 234) (and associated resources) through different means. In one technique a human operator 240 can manually input information regarding changes in the availability of the applications and associated resources. This operator 240 may represent an administrative person assigned the role of monitoring the system 200, or may be a programmer who is performing maintenance, upgrading or testing of equipment or machine readable code used by the system 200. The operator 240 can use a change-in-availability notification module 242 (referred to below as a “notification module” for brevity) to forward the availability information to the system 200. In one implementation, the notification module 242 can be implemented as any kind of computing device (such as a general purpose computer) having a suitably configured user interface (not shown) for soliciting the availability information from the operator 240.

In another case, the system 200 may employ various kinds of monitoring equipment and infrastructure for automatically monitoring the availability of different applications and resources provided by the system. This equipment and infrastructure is generally denoted in FIG. 2 as system monitoring functionality 244. The system monitoring functionality 244 can monitor the availability of hardware used to implement the applications and resources (e.g., to determine whether this hardware is powered on and functioning properly), and/or can provide various software monitoring mechanisms to determine whether the software used by the applications and resources is running properly. In the latter case, these software monitoring mechanisms can operate using various scripts, rules, counters, testing patterns, etc. The system monitoring functionality 244 can also interface with the system 200 via the notification module 242, or via some other module.

The notification module 242 can transmit the notification information to one of the server modules (202, 204, 206, . . . 208) of the system 200 using any protocol, such as a message queuing protocol. Message queuing protocols (such as MSMQ provided by Microsoft Corporation) enable communication across potentially heterogeneous systems and networks, parts of which may, at any given time, be temporarily offline. In this protocol, applications transmit messages to respective queues and retrieve message from respective queues. In the present case, messages sent using the message queuing protocol can include information expressed in the Extensible Markup Language (XML), or some other format. However, other protocols and mechanisms can be used to transmit notification information, such as the Simple Object Access Protocol (SOAP). SOAP provides a lightweight protocol to transfer information over networks or other kinds of distributed environments. This protocol provides an extensible messaging framework using XML to provide messages that can be sent on different kinds of underlying protocols. Each SOAP message includes a header block and a body element.

In general, the message transmitted to the system 200 can identify the application (or applications) that it pertains to. For instance, in one case, the message may convey that the unavailability status affects the entire system 200 and all of its applications; in another case, the message may indicate that the unavailability status affects only one application, or a small number of applications. Alternatively, the message can identify resources that are used by the applications, the availability of which affects the availability of the applications that use these resources. The message can also contain a timestamp which reflects when it was created and/or transmitted. This timestamp determines the message's priority; that is, later submissions regarding the same application override earlier submissions. Further, each message can contain additional information, such as a code which reflects a reason that the application is unavailable (if the application is assessed to be unavailable), an ID assigned to an operator who created the entry (if an operator 240 created it, as opposed to the system monitoring functionality 244), a time when the application is expected to go down, a time when the application is expected to become available again, and so on. Further still, the message can contain criteria which limit the applicability of the availability information to only certain kinds of requests made by the user 218, or other qualifications which make the applicability of the availability information conditional on other factors. Thus, a targeted application can be available for one kind of request, but unavailable for another kind of request. Still further fields of information can be conveyed by the message.

By way of overview, the system 200 disseminates the availability information in the request by sending it first to an initial server module. Assume, for the sake of discussion, that this initial server module corresponds to server module A 202. This initial distribution is illustrated in FIG. 2 as path 246. The initial server module A 202 then propagates the availability information to all of the other server modules (204, 206, . . . 208) in the system 200. FIG. 2 illustrates this propagation by the plural paths 248 linking the server module A 202 to the other server modules (204, 206, . . . 208).

The system 200 can use a variety of different techniques to determine which server module should act as the initial server module (which in this case is server module A 202). In one case, the system 200 can rely on load-balancing functionality (not shown) to determine which server module is best able to perform the role of the initial server module. For instance, the load-balancing functionality may assign this task to the server module currently handling the least amount of processing load. In another case, the system 200 may assign the role of initial server module to a predetermined server module, or a predetermined list of server modules; in the latter case, the system 200 can be configured to attempt to assign the role to the first server module in the list, and if this server module is unavailable, then the system 200 will attempt to assign the role to the second server module in the list, and so on). Still other techniques can be used to assign the role of the initial server module to one of the server modules in system 200.

Each server module includes functionality for receiving availability information and for acting on that availability information in the manner to be described below. This functionality is implemented by synchronization modules (250, 252, . . . ). That is server module A 202 provides synchronization module 250, while server module B 204 provides server module 252, etc. (The internal functionality of other server modules is not shown in FIG. 2 to simplify this drawing). Server module 250 includes a message queue 254, a repeater module 256, and merge logic 258. Server module 252 includes the same features, namely, a message queue 260, a repeater module 262, and merge logic 264. Other server modules (e.g., server module 206, . . . 208) include similar features, although not shown.

The function of the message queues (254, . . . 260) is to transport messages containing availability information according to a message queuing protocol. Generally, the receiving server module can order these messages according to their respective timestamps (which is related to the time that they were created and/or transmitted to the system 200). Also, the receiving server module can be configured so as to grant priority to certain messages based on various factors. For instance, certain messages can pertain to critical applications; accordingly the position of these messages in the queue can be taken “out of order” (that is, out of order with respect to the messages' timestamps). Still other types of priority schemes can be implemented depending on the processing environment in which the system 200 is employed.

The repeater modules (256, . . . 262) serve the function of storing the received availability information in files and propagating the availability information to various destinations via the messaging queues (254, . . . 260). For instance, in the case of the initial server module A 202, the repeater module 256 can transfer the availability information received via the message queue 254 into the appropriate application caches (224, 226, . . . 228) depending on the respective applications that the availability information pertains to. This is illustrated by the arrow that points from the message queue 254 to the repeater module 256, and the arrows that then point from the repeater module 256 to the respective application caches (224, . . . 228). The initial server module A 202 also uses the repeater module 256 to transfer the availability information to the respective message queues (260, . . . ) of the other server modules (204, 206, . . . 208) via the message queue 254. FIG. 2 represents this information transfer by paths 248.

Server module B 204 illustrates the role of the repeater module 262 in the context of a server module that receives availability information from the initial repeater module A 202. In this role, the message queue 260 of server module B 204 receives the availability information from the message queue 254 of the server module A 202. As described, the server module B 204 can store information in the order it was received, but can override this order in various priority situations. The repeater module 262 of the server module B 204 transfers the availability information received from the message queue 260 into appropriate application caches (230, 232, 234) based on the applications that the availability information pertains to. For example, consider the case where server module A 202 and server module B 204 implement exactly the same applications that access exactly the same resources (in other words, these server modules serve as redundant entities). In this case, the application caches (224, 226, . . . 228) of server module A 202 will receive the same availability information as the application caches (230, 232, . . . 234) of server module B 204. However, where server module A 202 and server module B 204 do not implement exactly the same applications, the fact that the repeater module 256 of server module A 202 uploads certain availability information to its application caches (224, 226, . . . 228) does not necessarily mean that repeater module 262 of server module B 204 will do the same with respect to its application caches (230, 232, . . . 234). The repeater modules implemented on other respective server modules (e.g., 206, . . . 208) behave in the manner specified above with respect to repeater module 262 of server module B 204.

The above description pertained to an implementation in which the initial server module (e.g., server module A 202) broadcasted new availability information to all of the other server modules (e.g., server modules 204, 206, . . . 208) in the system 200, as represented by paths 248. However, in another implementation, the system 200 can disseminate new availability information by propagating it from one server module to the next until all of the server modules have received the availability information. That is, this implementation could operate by using the message queue 254 of the initial server module A 202 to send the availability information to the message queue 260 of the next server module B 204, and then the message queue 260 of the server module B 204 could transfer the availability information to the message queue (not shown) of server module C 206, and so on. Still other dissemination strategies can be implemented.

Finally, the synchronization modules (250, 252, . . . ) include merge logic (258, 264, . . . ). The function of this logic (258, 264, . . . ) is explained below in the following section.

Functionality for Synchronizing Availability Information When a Server Module Resumes Operation after Having Been Inactive

The above section set forth a procedure whereby new availability information is propagating through the system 200 when it is initially introduced into the system 200 from the notification module 242. This serves to synchronize the application caches (224, . . . 234) of all of the server modules (202, 204, 206, . . . 208) so that they all have the most current availability information. However, for various reasons, one or more of the server modules (202, 204, 206, . . . 208) may stop working in a normal manner for a period of time. This event may be attributed to a failure in this server module, or may be attributed to an operator taking this server module offline to perform various maintenance, upgrading, testing, etc. of this server module. Or an operator may add one or more new server modules to the server farm. Whatever the cause, when this server module becomes operational again (or operational for the first time), it may not be in synchronization with the availability information maintained in the other server modules (which have been working continuously). For instance, these other server modules may have been receiving new availability information from the notification module 242. The server module that is being started up (referred to herein as the “starting server module”) may not “know” of this information, and is therefore out of synchronization with the other server modules that have been working continuously (referred to herein as the “reference server modules”). The merge logic (258, . . . 264) addresses this problem. Namely, the merge logic (258, . . . 264) can function in two different ways depending on its role in the synchronization operation. The purpose of the merge logic implemented on the starting server module is to discover the availability information stored in the reference server modules and to update its own application caches in accordance therewith. The purpose of the merge logic implemented on the reference server modules is to respond to the inquiries of the starting server module by informing the starting server module of what availability information is new. A server module can function as a starting server module at one instance of time and a reference server module at another instance of time.

FIG. 3 illustrates the functions performed by the merge logic (258, . . . 264) in greater detail. FIG. 3 again shows the exemplary server modules (202, 204, 206, . . . 208) of FIG. 2. Server module A 202 includes synchronization module 250, server module B 204 includes synchronization module 252, server module C 206 includes synchronization module 302, and server module n 208 includes synchronization module 304. The contents of the respective synchronization modules (250, 252, 302, . . . 304) are simplified to facilitate discussion, showing only the merge logic (258, 264, 306, . . . 308) contained therein. In the context of FIG. 3, assume that server module A 202 functions as a so-called starting server module, meaning, as described above, that it has been inactive for some time and that it is now becoming operational. The other server modules (204, 206, . . . 208) serve as reference server modules, meaning that these server modules act as the sources from which the starting server module A 202 can discover new availability information that was received by the system 200 during its period of inactivity.

As mentioned above, the basic goal of the synchronization procedure is to ensure that the application caches (224, 226, . . . 228) of the starting server module A 202 are up to date with respect to the availability information stored in the other reference server modules (204, 206, . . . 208). This can be accomplished, broadly speaking, by having the starting server module A 202 make an inquiry to at least one of the reference server modules (204, 206, . . . 208). More specifically, assume that the starting server module A 202 discovers all of the current availability information maintained by reference server module B 204; then, if server module B 204 has current information, the server module A 202 will likewise gain current information upon retrieving this information and loading it into its application caches (224, 226, . . . 228). However, depending on the processing environment, there may be a chance that server module B 204 may not have complete up to date availability information. This deficiency may be attributed to the fact that server module B 204 may not have yet received new availability information that is being propagated throughout the system 200 at the time that the starting server A 202 makes its inquiry. In view of this, the starting server module A 202 can also query server module C 206 to determine this server module's availability information. Reference server module C 206 can potentially supply availability information that was not conveyed by reference server module B 204. This process can be repeated for additional reference server modules, each time increasing the probability that the starting server module A 202 includes all of the new availability information that may exist in the system 200. The number of reference server modules that a starting serving module is configured to query can vary depending on the characteristics of the processing environment. In one case, the starting server module A 202 can only query one reference server module, and in another case, the starting server module A 202 can query, two, three, etc. reference server modules. In one implementation, the starting server module A 202 can be configured to access a predefined list of reference server modules (204, 206, . . . 208) when it becomes active. In another implementation, the starting server module A 202 can be configured to randomly select its reference server modules (204, 206, . . . 208), or use some other technique to select these reference server modules (204, 206, . . . . 208).

Having set forth the basic philosophy of the synchronization methodology, the exemplary specifics of this operation will be described. First, upon becoming operational again (or starting up for the first time), the starting server module A 202 will restore the availability information contents of its stores that may have existed at the time of shut down. The starting server A 202 then acts on any transactions that may have been pending at the time it became inactive. This can entail transferring pending availability information from its repeater 256 and then to its application caches (224, 226, . . . 228).

Then assume that the starting server module A 202 first seeks to discover the availability information that reference server module B 204 contains. It performs this task by sending a message to reference server module B 202. This message may include information that reflects the starting server A 202's “understanding” of the current status of the availability information. Upon receiving this message, the merge logic 260 of server module B 204 seeks to determine whether it has any availability information that is not specified in the availability information received from server module A 202. It can perform this function in different ways. One way is to merge the set of availability information received from server module A 202 with the set of availability information currently maintained by server B 204 to form a union set that comprises all the entries in both sets of availability information, but which removes duplicate entries. This union set (i.e., A u B) can then be transmitted back to the merge logic 258 of server module A 202, where this union set is merged with the availability information currently maintained by server module A 202. The result of this operation therefore yields all of the current availability information according to the universe of server modules defined by at least server module A 202 and server module B 204. The server module A 202 can then act on this updated information by loading it into its respective application caches (224, 226, . . . 228). At this juncture, the state of the availability information in server module A 202 can be represented as A′=A u B.

As described above, gleaning new availability information from reference server module B 204 has a high likelihood of capturing the most current state of the system 200 (e.g., assuming that reference server module B 204 was active while starting server module A 202 was inactive). But depending on the type of environment, this likelihood may not be 100 percent. To increase the likelihood of capturing the most current state, the starting server A 202 can repeat the above-described process using server module C 206, which prompts server module C 206 to respond with availability information defined by the union of the set of availability information currently maintained by server module A 202 and the set of availability information maintained by server module C 206 (i.e., A′ u C). Updating server module A 202 to incorporate this union yields an availability state A″=A′ u C, which is equivalent to (A u B) u C. If this process is repeated with respect to server module n 208, the server module n 208 will return the response A″ u n, which is equivalent to ((A u B) u C) u n, and the likelihood that the starting server module A 202 then contains the most current information maintained in the system 200 will become even greater. Effectively, it can be said that the starting server module A 202 passes all of the availability information that it knows about upon each successive query to a reference server module.

In general, the system 204 can be configured to perform the above-described operations in series for reference server module B 204, then reference server module C 206, and so on. Alternatively, server module A 202 can broadcast its inquiries to all of the reference server modules (204, 206, . . . 208) at the same time, whereupon the merging performed by these reference server modules (204, 206, . . . . 208) can occur in parallel. The starting server module A 202 can then also receive responses back from the respective reference server modules (204, 206, . . . 208) in parallel. The collected responses can be used to update the starting server module A 202.

In addition, the reference server modules (204, 206, . . . 208) can also update their application caches (230, 232, . . . 234) on the basis of availability information received from the starting server module A 202, which can also incorporate availability information collected from other server modules (e.g., as in the case of availability set A′, A″, etc. discussed above). That is, while the main goal of the synchronization procedure is to bring the application caches (224, 226, . . . 228) of the starting server module A 202 up to date with respect to availability information maintained by reference server modules (204, 206, . . . 208), it is also useful to update the reference server modules (204, 206, . . . 208) based on availability information that these reference server modules (204, 206, . . . 208) obtain from the starting server module A 202. This is because there is a chance that the starting server module A 202 may include some availability information that is not shared by at least one other reference server module. Thus, when the reference server modules (204, 206, . . . 208) perform a merge based on the availability information obtained from the starting server module A 202, they can also use the resultant union set to update their own application caches (e.g., 230, 232, . . . 234).

By virtue of the above-described synchronization procedure, server module n 208 can be assured to receive all of the current availability information offered by server modules B 204 and C 206 (because server module n 208 has received A″=A′ u C, which is equivalent to (A u B) u C). However, suppose that server module C 206 or server module n 208 offered new availability information when they were queried. In this case, the algorithm described above would not propagate this information to server module B 204 (because such information was discovered by server module A 202 after it had finished communicating with server module B 204). To address this situation, server module A 202 can be configured to keep track of those server modules that have not been notified of new availability information. After server module A 202 finishes investigating each of the server modules in sequence, it can then determine whether some of the server modules may have missed out on receiving updated availability information (because of their “position” within the polling sequence). It can then notify each of these server modules of the availability information that they may have missed.

The merge logic (258, 264, 306, . . . 308) can perform its merging functionality by storing the respective sets of availability information in a store that is idempotent. If an idempotent store receives the same entry twice, it will maintain only one version of this entry. Accordingly, if set (a, b, c, d) is merged with set (c, d, e, f), the result will be (a, b, c, d, e, f), because the idempotent store will keep only one copy of entries c and d. The above-described technique for alerting the starting server module A 202 of the existence of new availability information maintained by other reference server modules (204, 206, . . . 208) is only one exemplary technique for performing this operation; other techniques can be used.

B. Exemplary Method of Operation

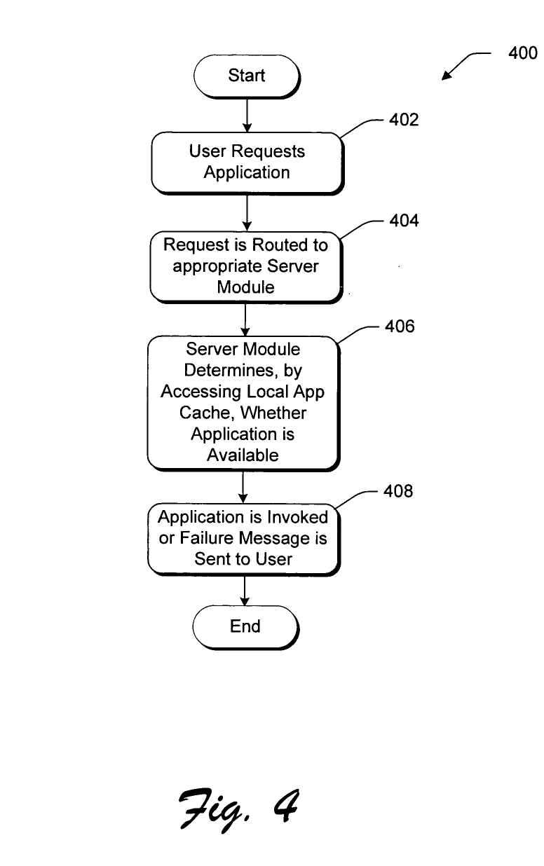

The flow charts in FIGS. 4-7 summarize the functionality described in Section A. In general, to facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure.

Determining Application Availability Using Application Caches

To begin with, FIG. 4 describes a procedure 400 for using the system 200 of FIG. 2 to respond to the user 218's request for services. In step 402, the user 218 makes an inquiry to the system 200, e.g., using requesting module 220 (which may comprise a personal computer or an application-specific device). In step 408, the request is routed to one of the server modules (202, 204, 206, . . . 208) in the system. This routing can be made based on addressing information in the request itself and/or based on load-balancing considerations. In step 406, the allocated server module determines the availability of the application invoked by the request by querying the application cache associated with this application. The information in the application cache defines whether the application is available or unavailable. If it is unavailable, the information in the application cache may also provide reasons why it is unavailable (and optionally can include additional supplemental information regarding the unavailable status). In step 408, the appropriate server module performs the application (if it is available) or sends an error message to the user 218 alerting the user 218 of the unavailability of the application (and optionally, the reasons why the application is unavailable, etc.).

As mentioned above, the use of the application caches (224, . . . 234) to alert the user 218 to the unavailability of applications improves the user 218's experience in interacting with the system 200. For instance, due to the use of local application caches, the user 218 is quickly notified of unavailable applications, thus reducing the chance that the user 218 will waste efforts interacting with the system 200 only to later find out that he or she cannot successfully complete a transaction because some system resource is inactive. The use of availability information provides other benefits, which were set forth in the preceding section.

Disseminating Resource Information to the Distributed Application Caches

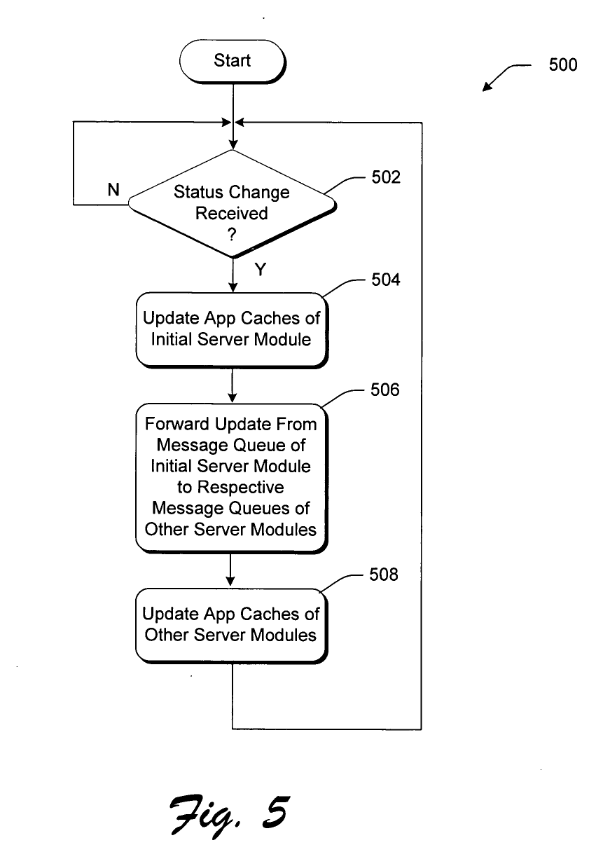

FIG. 5 describes a procedure 500 for disseminating availability information from a server module that initially receives new availability information from the notification module 242 to the other server modules in the system 200. In the context of FIG. 2, this procedure entails disseminating information first received at server module A 202 (referred to as the initial server module) to the other sever modules (204, 206, . . . 208).

In step 502, the procedure 500 determines whether the status of any application in the system 200 has changed. This can correspond to the case where an operator 240 has entered new availability information into the notification module 242 or the system monitoring functionality 244 has detected a change in the system 200, which, in either case, causes the notification module 242 to transmit a message to the message queue 254 of the initial server module A 202. In step 504, the initial server module A 202 loads this new availability information into its own applications caches (224, 226, . . . 228) using its repeater module 256. In step 506, the message queue 254 of the initial server module A 202 transfers the new availability information to the respective message queues (260, . . . ) of the other server modules (204, 206, . . . 208). This transfer can take place in parallel, where the initial server module A 202 broadcasts the new availability information to all of the other server modules (204 206, . . . 208) at the same time, or it can occur in series, where one server module is updated after another in series. In any event, in step 508, the other server modules (204, 206, . . . 208) act on the new availability information by loading it from their respective message queues (260, . . . ) into their respective application caches (230, 232, . . . ) using their respective repeater modules (262, . . . ). In general, each repeater is configured to distinguish update messages it receives from “outside” sources (such as the notification module 242) from messages that it receives from other repeaters, and process these messages accordingly.

Synchronizing Availability Information When a Server Module Resumes Operation After Having Been Inactive

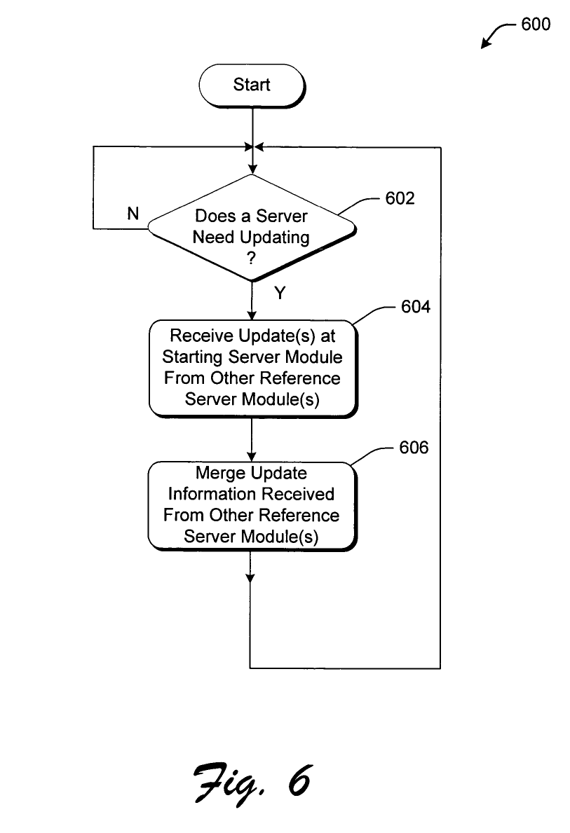

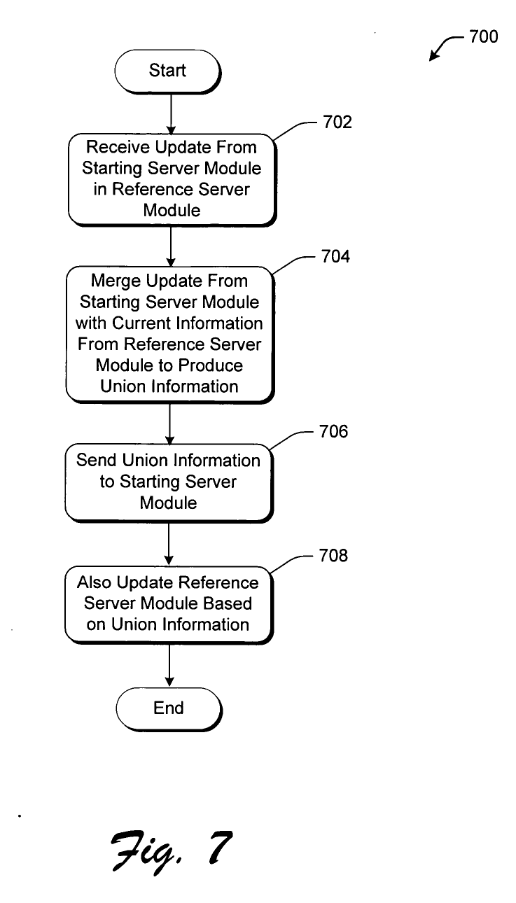

FIGS. 6 and 7 describe two procedures (600, 700) for synchronizing the system 200 when one of the server modules (202, 204, 206, . . . 208) resumes operation after it has been inactive for any reason, or starts up for the first time. For instance, the inactive server module may have been rendered inoperable because of a failure of some sort, or it may have been rendered inoperable because it was deliberately brought offline to perform maintenance, upgrading, testing. More specifically, FIG. 6 addresses the part of the synchronization operation from the vantage point of the server module that is being started up (again referred to as the “starting server module”), while FIG. 7 addresses the part of the synchronization operation from the vantage point of the other server modules which serve as references to the starting server module by supplying current availability information to the starting server module (where these other server modules are again referred to as “reference server modules”). In the context of FIG. 3, the server module A 202 functions as the starting server module, and the other server modules (204, 206, . . . 208) function as reference server modules. This arbitrary scenario will serve as the basis of the discussion below.

To begin with, step 602 of FIG. 6 involves determining whether a server module needs updating. This can be satisfied when, as described above, a starting server module has been inactive for any reason, and it is detected that it now wishes to become operational again. The system 200 can detect this event by virtue of the starting server module sending a predetermined startup signal to the other serve modules, or by virtue of some other mechanism. In step 604, the starting server module—in this case starting server module A 202—receives update information from one or more other reference server modules (204, 206, . . . 208). As described in connection with FIG. 3 above, this operation can entail transmitting the set of availability information maintained by the starting server module A 202 to a reference server module (e.g., reference server module B 204), merging the set of availability information received from the starting server module A 202 with the set of availability information maintained by the reference server module B 204 to provide a union set, and then transmitting this union set back to the starting server module A 202. In step 606, the starting server module A 202 receives this union set and merges it with its current set of availability information. This procedure can be performed once with respect to one reference server module, or can be performed with respect to multiple reference server modules. In any case, the merging can be implemented by feeding different sets of availability information maintained by different server modules into an idempotent store. If the idempotent store receives a copy of an entry that it already contains, it will store only one copy of this entry. That is, it will not store duplicate entries.

Procedure 700 of FIG. 7 describes the synchronization procedure from the vantage point of a reference server module, e.g., reference server module B 204. In step 702, the reference server module B 204 receives availability information from the starting server module A 202. In step 704, the reference server module B 204 merges the set of availability information obtained from the starting server module A 202 with the set of availability information obtained by the reference server module B 204 to provide a union set. In step 706, the reference server module B 204 sends the union set to the starting server module A 202, whereupon the starting server module A 202 loads any new information contained therein in its application caches (224, 226, . . . 228). (Alternatively, if the reference server module B 204 determines that the union set A u B does not contain any information beyond that specified in set A, it need not send a message back to the starting server module A 202.) In step 708, the reference server module B 204 can update its own application caches (230, 232, . . . 234) based on any new information that it may have gleaned from the starting server module A 202. That is, while the main purpose the synchronization procedure is to bring the starting server module A 202 up to date with respect to current availability information in the system 200, there is a chance that the starting server module A 202 may having availability information that is new to the reference server module B 204. Step 708 accounts for this possibility by providing a mechanism for updating the application caches (230, 232, . . . 234) of the reference server module B 204. Although not shown in FIG. 7, the reference server module B 204 may also later receive a follow up update from the starting server module A 202. This follow up update may include any new availability information that the starting server module A 202 has discovered in the course of querying reference server module C 206, reference server module n 208, and so on.

In closing, a number of examples were presented in this disclosure in the alternative (e.g., case X or case Y). In addition, this disclosure encompasses those cases which combine alternatives in a single implementation (e.g., case X and case Y), even though this disclosure may have not expressly mentioned these conjunctive cases in every instance.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for synchronizing a system including plural server modules, comprising:
receiving notification information at a first server module regarding a change in the system;
acting on the notification information in the first server module; and
propagating the notification information from the first server module to at least a second server module,
wherein the notification information comprises an indication of whether or not at least one application used by the system is available to service user requests.

2. The method according to claim 1, wherein the acting on the notification information in the first server module comprises:
uploading the notification information into at least one application store associated with at least one respective application provided by the first server module.

3. The method according to claim 1, wherein the propagating comprises transferring the notification information using a first queue provided by the first server module to a second queue provided by the second server module.

4. The method according to claim 1, further comprising acting on the notification information in the second server module.

5. The method according to claim 4, wherein the acting on the notification information in the second server module comprises uploading the notification information into at least one application store associated with at least one respective application provided by the second server module.

6. The method according to claim 1, further including repeating the propagating for at least one additional server module in the system.

7. A computer readable medium including machine readable instructions for implementing the receiving, acting and propagating of claim 1.

8. A method for synchronizing a system including plural server modules, comprising:
forwarding first status information reflecting a state in a first server module to a second server module;
merging the first status information with second status information, where the second status information reflects a state of the second server module, to produce merged information;
sending the merged information from the second server module to the first server module; and
acting on the merged information at the first server module.

9. The method according to claim 8, wherein the first and second status information includes notification information regarding a change in the system.

10. The method according to claim 9, wherein the notification information comprises an indication of whether or not at least one application used by the system is available to service user requests.

11. The method according to claim 8, wherein the forwarding of first status information is prompted by the first server module becoming active after having remained inactive for some time.

12. The method according to claim 8, wherein the merging comprises combining the first status information with the second status information to provide a non-duplicative union of the first status information and the second status information.

13. The method according to claim 8, wherein the acting comprises uploading the merged information into at least one application store associated with at least one respective application provided by the first server module.

14. The method according to claim 8, further comprising repeating the forwarding, merging, sending and acting for at least one other server module.

15. A computer readable medium including machine readable instructions for implementing the forwarding, merging, sending and acting of claim 8.

16. A method of advising a user of the availability of an application in a system including plural server modules, comprising:
receiving, at a server module in the system, a user's request for an application;
consulting an application store associated with the application to determine whether the application is unavailable, and, if so generating a response; and
forwarding the response to the user, wherein each of the plural server modules in the system maintains its own respective application store.

17. A computer readable medium including machine readable instructions for implementing the receiving, consulting and forwarding of claim 16.

18. A synchronization module implemented on a first server module in a system including plural server modules, comprising:
repeater logic configured to:
receive notification information pertaining to a change in the system;
upload the notification information into at least one application store associated with at least one respective application; and
propagate the notification information from the first server module to at least a second server module,
wherein the notification information uploaded to said at least one application store comprises an indication of whether or not said at least one application is available to service user requests.

19. The synchronization module according to claim 18, further including a message queue, wherein the repeater module is configured to receive the notification information and propagate the notification information using the message queue.

20. The synchronization module according to claim 18, wherein the synchronization module is configured to propagate the notification information to at least one other server module in the system.

21. A computer readable medium including machine readable instructions for implementing the repeater logic of claim 18.

22. A synchronization module for synchronizing a system including plural server modules, comprising:
merge logic configured to:
forward first status information reflecting a state in a first server module to a second server module; and
receive merged information from the second server module, wherein the merged information reflects a merging of the first status information with second status information, the second status information reflecting a state of the second server module; and
a repeater module configured to act on the merged information.

23. The synchronization module according to claim 22, wherein the first and second status information includes notification information regarding a change in the system.

24. The synchronization module according to claim 23, wherein the notification information comprises an indication of whether or not at least one application used by the system is available to service user requests.

25. The synchronization module according to claim 22, wherein the merge logic is configured to send the first status information when the first server module becomes active after have remained inactive for a predetermined time.

26. The synchronization module according to claim 22, wherein the repeater module is configured to act on the merged information by uploading the merged information into at least one application store associated with at least one respective application provided by the first server module.

27. The synchronization module according to claim 22, wherein the merge logic is configured to repeat the forwarding and receiving for at least one other server module.

28. A computer readable medium including machine readable instructions for implementing the merge logic of claim 22.

29. A server module for advising a user of the availability of an application in a system including plural server modules, comprising:
an application store associated with the application;
logic configured to receive, at a first server module in the system, a user's request for an application;
logic configured to consult the application store to determine whether the application is unavailable, and, if so, to generate a response; and
logic configured to forward the response to the user,
wherein each of the plural server modules in the system maintains its own respective application store.

30. A computer readable medium including machine readable instructions for implementing the receiving, consulting and forwarding of claim 29.
